(19) United States
(12) Patent Application Publication
(10) Pub. No.: US 2003/0172972 A1
(43) Pub. Date: Sep. 18, 2003

(54) Replaceable check valve seats

(75) Inventor: Lyle E. Marvin, Galena, KS (US)

Correspondence Address: MICHAEL BEST & FRIEDRICH LLP, 3773 CORPORATE PARKWAY, SUITE 360, CENTER VALLEY, PA, 18034-8217, US

(73) Assignee: Ingersoll-Rand Company, Woodcliff Lake, NJ

(21) Appl. No.: 10/092,228

(22) Filed: Mar. 6, 2002

(51) Int. Cl. F16K 15/00

(52) U.S. Cl. 137/512.1

(57) ABSTRACT

A valve seat insert for a check valve poppet, the valve seat insert having a thickness and an aperture located through the thickness and configured to accept a high pressure outlet passageway. The valve seat insert includes a plurality of bores that are located through the thickness and spaced around the aperture. The plurality of bores is located for registration with inlet passages of a check valve body to which the valve seat insert is to be attached. The plurality of bores may also be disposed circumferentially around and in fluid communication with a circumferential groove located in the thickness of the valve seat insert. Also provided is an inlet valve assembly that includes the valve seat insert and has a check valve body with a boss and a plurality of inlet passages surrounding a high pressure outlet passageway.

### FIELD OF THE INVENTION

The present invention relates generally to check valve seats for reciprocating piston pumps that deliver a flow of high-pressure water, and more particularly, but not by way of limitation, to replaceable check valve seats for use in sealing an intensifier pump utilized for pumping fluids.

### BACKGROUND OF THE INVENTION

There are in the prior art various pressure intensifying systems where a larger working piston is reciprocated to provide a high pressure output through smaller high pressure pistons or plungers that reciprocate within high pressure cylinders.

These pressure intensifying systems are useful for a variety of purposes including waterjet cutting systems having cutting heads equipped with nozzles that direct high pressure and high velocity jets of water to cut, drill, and shape workpieces. For such processes, intensifiers are used to increase the pressure of supply water to pressures above 40,000 psi. Examples of high pressure intensifiers for producing a high velocity fluid jet stream are shown and described in U.S. Pat. Nos. 3,811,795 and 5,092,744, which patents are incorporated herein by reference. The high pressure water is delivered from the intensifier to the cutting head and discharged through nozzles as waterjets which cut workpieces.

In generating the high pressures required for waterjet machining operations, however, the component parts of the intensifiers used are subjected to corrosion and wear over time. As a result, this leads to frequent repair of these component parts which is both costly from the standpoint of replacement parts, labor intensive maintenance, and lost production due to machine downtime.

The foregoing illustrates limitations known to exist in present high pressure hydraulic devices. Thus it is apparent that it would be advantageous to provide an alternative directed to overcoming one or more of the limitations set forth above. Accordingly a support for a seal of a pump is provided including the features more fully disclosed hereinafter.

### SUMMARY OF THE INVENTION

According to the present invention, a replaceable valve seat insert for a check valve poppet is provided in the form of an annular member having a thickness and an aperture located through the thickness and configured to accept a high pressure outlet passageway. The valve seat insert includes a plurality of bores that are located through the thickness and spaced around the aperture. The plurality of bores is located for registration with inlet passages of a check valve body to which the valve seat insert is to be attached. The plurality of bores may also be disposed circumferentially around and in fluid communication with a circumferential groove located in the thickness of the valve seat insert. Also provided is an inlet valve assembly that includes the valve seat insert and has a check valve body with a boss and a plurality of inlet passages surrounding a high pressure outlet passageway.

The foregoing and other aspects will become apparent from the following detailed description of the invention when considered in conjunction with accompanying drawing figures.

### DESCRIPTION OF THE DRAWINGS

FIG. 1 is a partial cross-sectional view of a reciprocating pump in the form of a conventional pressure intensifier;

FIG. 2 is an exploded perspective view showing a conventional check valve body of the pressure intensifier shown in FIG. 1;

FIG. 3 is a cross-sectional view of an assembled conventional check valve body of the pressure intensifier shown in FIG. 1;

FIG. 4 is an exploded perspective view showing a check valve body having a valve seat insert according to the present invention;

FIG. 5 is a cross-sectional view of an assembled check valve body having a valve seat insert according to the present invention; and

FIG. 6 is a perspective view of a valve seat insert according to another embodiment of the present invention.

### DETAILED DESCRIPTION OF THE PREFERRED EMBODIMENTS

The invention is best understood by reference to the accompanying drawings in which like reference numbers refer to like parts. It is emphasized that, according to common practice, the various dimensions of component parts as shown in the drawings are not to scale and have been enlarged for clarity.

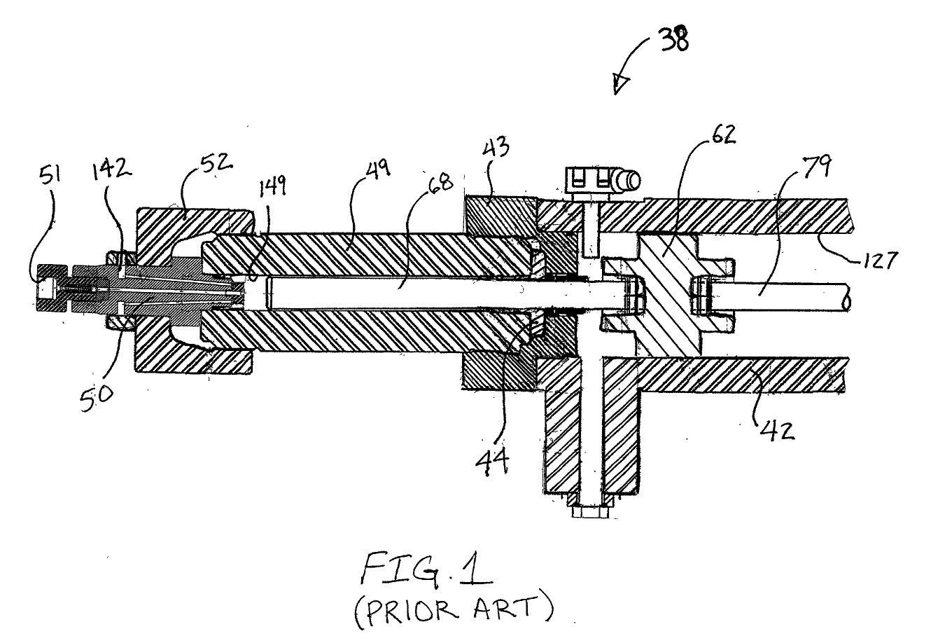

Referring now to the drawings, shown in FIG. 1 is a partial sectional view of an intensifier 38 for a waterjet cutting system having a central power cylinder 42 comprising a piston 62 attached to plungers 68 and 79. Piston 62 is located within a hydraulic fluid chamber 127 defined by the inside surface of power cylinder 42 upon which piston 62 slides.

Power cylinder 42 is attached to a first high pressure cylinder 49 by a head 43 that closes one end of power cylinder 42 and a retaining flange 44 that is inserted in one end of high pressure cylinder 49. To regulate the low pressure water passing into and high pressure water passing out of intensifier 38, a check valve body 50 is inserted into the end of high pressure cylinder 49 and held in place by a cap 52 to define a pumping chamber 149. A similar second high pressure pump cylinder (not shown) is located adjacent the outside of a second head (not shown) attached to an opposite end of the power cylinder.

In use, hydraulic fluid is alternately supplied under pressure to opposite ends of hydraulic fluid chamber 127 of power cylinder 42 thereby reciprocating piston 62 therein. Piston 62 being connected to the plungers 68 and 79, in turn, causes the reciprocating pumping of the plungers 68 and 79. As plunger 68 moves to the left in high pressure cylinder 49, low pressure water fed from an inlet passage 142 to a pumping chamber 149 is passed out of an outlet 51 at high pressure, as is known in the art.

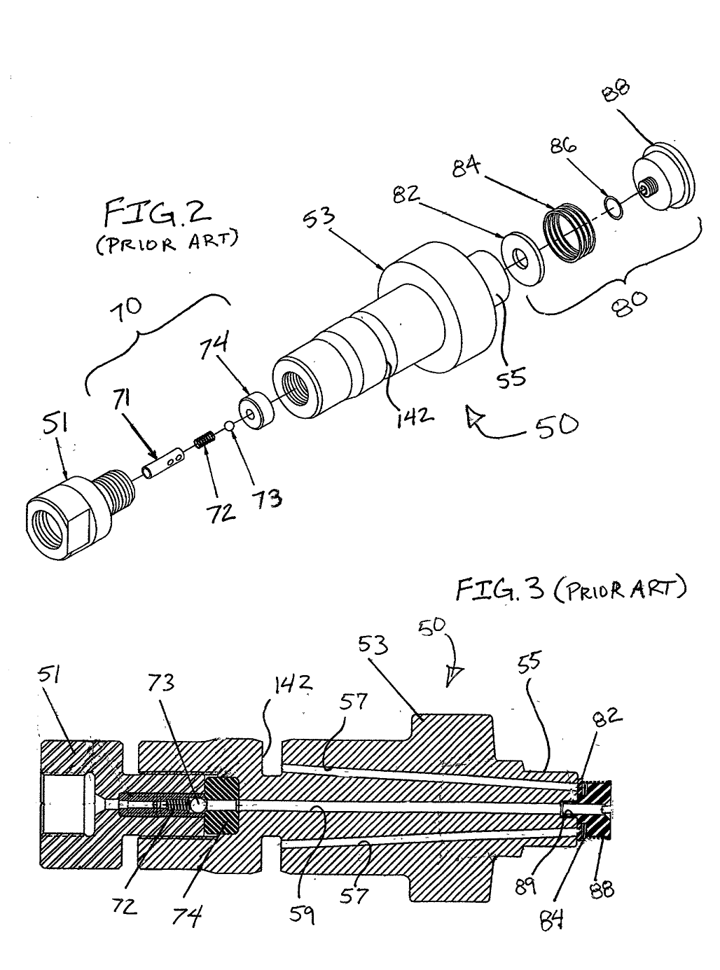

Shown in the enlarged view of FIG. 2, is a check valve body 50 that regulates the low-pressure water passing into and high-pressure water passing out of pumping chamber 149 and, generally, is made of a metal such as a stainless steel. As shown in FIG. 1, check valve body 50 is located in engagement with the outer end of cylinder 49 by cap 52 which threadingly engages the outer surface of cylinder 49.

Check valve body 50 includes a check valve housing 53 having an outlet valve assembly 70 disposed in one end and in fluid communication with a longitudinal outlet passage 59 located within check valve housing 53. Outlet valve assembly 70 includes a guide sleeve 71, a spring 72, a moveable check ball 73, and seat 74 retained within check valve housing 53 by threaded outlet 51 as is known in the art and shown in FIG. 3. Spring 72 biases check ball 73 into closed relationship relative to seat 74 as seen in FIG. 3. As discussed in greater detail below, when the pressure in pumping chamber 149 is sufficient to overcome the force of spring 72, check ball 73 will move to the open position to allow high pressure water to flow through outlet passage 59 of the intensifier.

On an opposite end, check valve body 50 has a cylindrical boss 55 having an end face that extends into pumping chamber 149 as shown in FIG. 1. An inlet valve assembly 80 having a poppet 82, which is an annular member that seats against the end of boss 55, is held in place by a spring 84, an O-ring 86, and a threaded retaining screw 88, as is known in the art. Poppet 82 is typically made of a polished metal to provide better sealing against the end of boss 55. Threaded retaining screw 88 includes a bore 89 that communicates with and connects longitudinal outlet passage 59 to pumping chamber 149.

As seen best in FIG. 3, check valve housing 53 has a plurality of inlet passages 57 that connect an inlet passage 142 attached to a water supply (not shown), to inlet valve assembly 80. During the intake stroke of plunger 68, poppet 82 which normally is compressed against boss 55, moves to the open position whereby water under relatively low pressure flows from inlet passage 142, through inlet passages 57, around poppet 82 into pumping chamber 149.

When the direction of movement of plunger 68 is reversed, plunger 68 moves toward inlet valve assembly 80 whereby the pressure of the water in pumping chamber 149 substantially increases to the high pressure range causing poppet 82 to quickly close and check ball 73 to move away from seat 74, thereby permitting high-pressure water to flow through longitudinal outlet passage 59 and out connector 51.

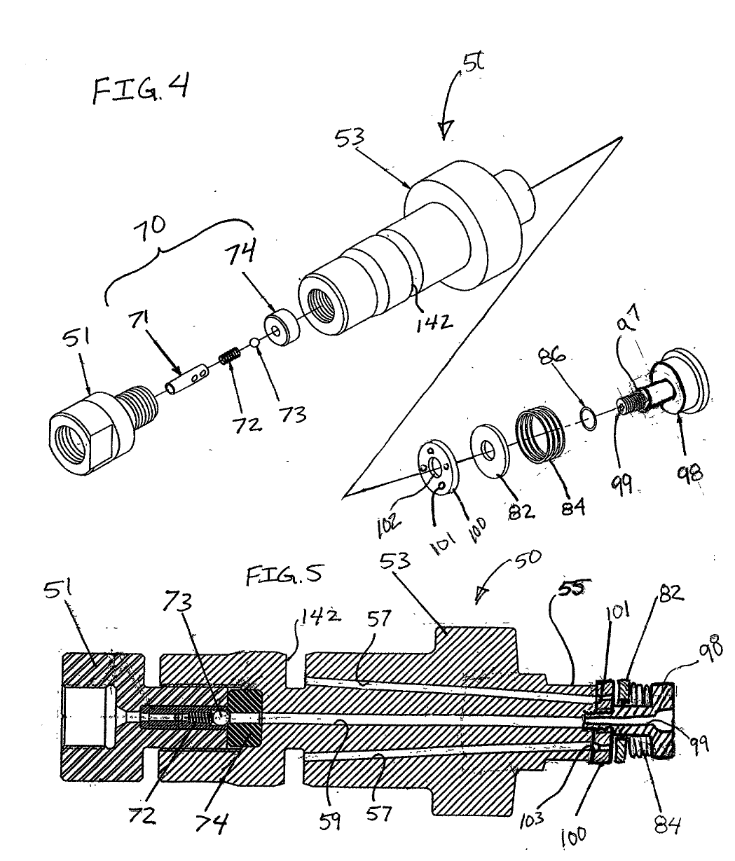

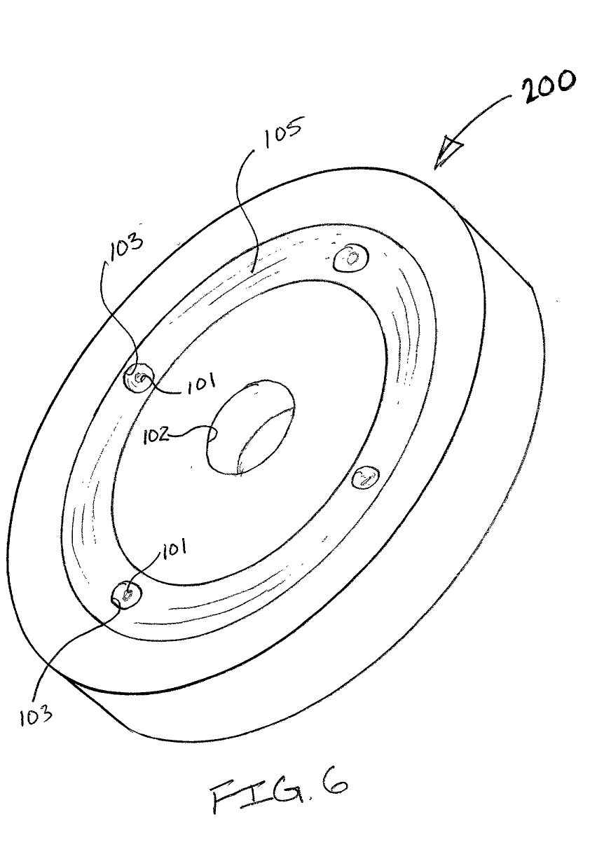

With a conventional inlet valve assembly such as that shown in FIGS. 1, 2, and 3, however, it has been discovered by the present inventor that problems are generally encountered due to water leakage at the interface between the poppet 82 and the boss 55 which causes heating and jetting erosion of the polished metal sealing surfaces between these components. Although the poppets of prior art inlet check valves are replaceable when worn, the surface of the boss against which the poppet is seated must either be repolished or otherwise reconditioned requiring labor intensive maintenance and causing lost production due to machine downtime. According to the present invention a replaceable valve seat insert 100 is provided in the form of an annular member having a plurality of bores 101 located through the thickness and spaced about an aperture 102. Preferably, the plurality of bores 101 comprise a funnel portion 103 and are circumferentially spaced around aperture 102 which is centrally located in valve seat insert 100. As shown in FIGS. 4 and 5, the valve seat insert 100 is disposed between the seating surface end of boss 55 and poppet 82 with the plurality of bores 101 being located so they are in registration with inlet passages 57 upon aligning and mounting the valve seat insert 100 onto the end of boss 55 using a threaded retaining screw 98. As shown in FIGS. 4 and 5, threaded retaining screw 98 is similar to threaded retaining screw 88 in that it includes a bore 99 for communicating with and connecting longitudinal outlet passage 59 to pumping chamber 149. Additionally, threaded retaining screw 98 includes a shoulder portion 97 that clamps valve seat insert 100 against the seating surface end of boss 55 upon tightening the threaded retaining screw 98 into check valve housing 53 as shown in FIG. 5.

In an alternative embodiment of the present invention, shown in FIG. 6 is a valve seat insert 200 in which the plurality of bores 101 are disposed circumferentially around and in fluid communication with a circumferential groove 105 located in the thickness of the valve seat. Preferably, the plurality of bores 101 each include a funnel portion 103 located in the circumferential groove 105. By this configuration, circumferential groove 105 equalizes the pressure of water between the plurality of bores 101, thereby further reducing erosion that may occur at the interface between boss 55 and valve seat insert 200.

With respect to materials selections for valve seats according to the present invention, they are preferably made of materials that are the same as or similar in hardness to the material of boss 55 against which the valve seat inserts are attached.

Thus, low-cost replaceable valve seat inserts according to the present invention are provided that may be originally provided with or retrofitted to existing sealing heads of a check valve body that can greatly increase the service life of the seal head.

While embodiments and applications of this invention have been shown and described, it will be apparent to those skilled in the art that many more modifications are possible without departing from the inventive concepts herein described. It is understood, therefore, that the invention is capable of modification and therefore is not to be limited to the precise details set forth. Rather, various modifications may be made in the details within the scope and range of equivalents of the claims without departing from the spirit of the invention.

What is claimed is:

1. A valve seat insert for a check valve poppet, the valve seat insert having a thickness and comprising:
an aperture located through the thickness and configured to accept a high pressure outlet passageway,
a plurality of bores located through the thickness and spaced around the aperture, the plurality of bores being located for registration with inlet passages of a check valve body to which the valve seat insert is to be attached.

2. The valve seat according to claim 1, wherein the plurality of bores further comprise a funnel portion.

3. The valve seat according to claim 1, wherein the aperture is centrally located in the valve seat insert.

4. The valve seat insert according to claim 1, wherein the plurality of bores are circumferentially spaced around the aperture.

5. The valve seat according to claim 4, wherein the plurality of bores further comprise a funnel portion.

6. The valve seat according to claim 4, wherein the aperture is centrally located in the valve seat insert.

7. The valve seat according to claim 1, wherein the plurality of bores are disposed circumferentially around and in fluid communication with a circumferential groove located in the thickness of the valve seat insert.

8. The valve seat according to claim 7, wherein the plurality of bores further comprise a funnel portion.

9. The valve seat according to claim 7, wherein the aperture is centrally located in the valve seat insert.

10. An inlet valve assembly, comprising:
a check valve body having a boss with a plurality of inlet passages surrounding a high pressure outlet passageway;
a check valve poppet; and
a valve seat insert disposed between the boss and the check valve poppet, the valve seat insert having a thickness and comprising:
an aperture located through the thickness and configured to accept a high pressure outlet passageway, and
a plurality of bores located through the thickness and spaced around the aperture, the plurality of bores being located for registration with the inlet passages of the check valve body.

11. The inlet valve assembly according to claim 10, wherein the valve seat and the valve seat insert are attached to the boss by a threaded retaining screw disposed through the aperture.

12. The inlet valve assembly according to claim 11, wherein the threaded retaining screw comprises a longitudinal bore that communicates with and extends the longitudinal high pressure outlet passageway through the valve seat and the valve seat insert.

13. The inlet valve assembly according to claim 12, wherein the threaded retaining screw further comprises a shoulder portion that clamps the valve seat insert against the boss upon tightening the threaded retaining screw into the boss.

14. The inlet valve assembly according to claim 10, wherein the plurality of bores further comprise a funnel portion.

15. The inlet valve assembly according to claim 10, wherein the plurity of bores are disposed circumferentially around and in fluid communication with a circumferential groove located in the thickness of the valve seat insert.

16. The inlet valve assembly according to claim 15, wherein the plurality of bores further comprise a funnel portion.
